(19) United States
(12) Patent Application Publication
(10) Pub. No.: US 2009/0207344 A1
(43) Pub. Date: Aug. 20, 2009

(54) Illuminating device and liquid crystal display device

(76) Inventors: Masashi Ono, Chiba-shi (JP); Makoto Kurihara, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/378,188

(22) Filed: Feb. 11, 2009

(30) Foreign Application Priority Data
Feb. 19, 2008 (JP) 2008-037170
Dec. 22, 2008 (JP) 2008-326195

(51) Int. Cl. G02F 1/13357; F21V 7/04

(52) U.S. Cl. 349/65; 362/620; 362/626

(57) ABSTRACT

In an illuminating device, a plurality of light reflecting portions each including a plurality of prisms adjacent to one another are formed on one of an opposing surface and an exit surface of a light guide plate so as to be spaced apart from one another. Each of the plurality of prisms is in a shape of a triangle in section with one of the opposing surface and the exit surface being a base of the triangle, and is formed so as to protrude therefrom. Light introduced from a light source is reflected by the plurality of prisms to be illuminating light having directivity in a vertical direction. Light which has passed through a prism which is nearer to the light input portion is again taken into the light guide plate by an adjacent prism at a subsequent stage and can be reused.

### BACKGROUND OF THE INVENTION

1. Field of the Invention

The present invention relates to an illuminating device having a flat light emitting surface and to a liquid crystal display device using the same.

2. Description of the Related Art

A liquid crystal display device is widely used in mobile equipment such as a notebook personal computer, a cellular phone, a personal data assistant (PDA), and an electronic dictionary. A liquid crystal panel used in the liquid crystal display device does not emit light itself, and thus, it is necessary to integrate a flat illuminating device at a back of the liquid crystal panel. An illuminating device for mobile equipment is required to be thin, and to have high brightness so that display can be visually recognized even outside during daytime. Further, uniform light emission is desired so that the brightness of displayed images is uniform. Accordingly, a side-light type illuminating device including a light source located at a side of a light guide plate has been studied, because the side-light type illuminating device can be formed so as to be thin as a whole.

FIG. 9 is a schematic longitudinal sectional view of a conventional liquid crystal display device 50. The liquid crystal display device 50 includes a liquid crystal panel 51 for converting an image signal into a displayed image, an illuminating device 61 provided therebelow having a light source 59, a light guide plate 58, and a reflector plate 60, a light diffuser plate 57 provided above the illuminating device 61, and a prism sheet 56 provided between the light diffuser plate 57 and the liquid crystal panel 51. The liquid crystal panel 51 includes a liquid crystal layer (not shown) sandwiched between upper and lower transparent substrates 52 and 53, and upper and lower polarizing plates 54 and 55 provided on outer surfaces of the transparent substrates 52 and 53, respectively. The light guide plate 58 of the illuminating device 61 introduces, from a side edge portion thereof, light emitted from the light source 59, and emits diffused light upward on a side of the liquid crystal panel 51 or downward on a side of the reflector plate 60 (edge light method). The reflector plate 60 is provided for reflecting upward light which leaks from a bottom of the light guide plate 58 to make higher use efficiency of the light. The light diffuser plate 57 is provided for diffusing light emitted from the illuminating device 61 to obtain uniform illuminating light.

The prism sheet 56 is formed by laminating a prism sheet 56a having a plurality of grooves in an X direction provided therein and a prism sheet 56b having a plurality of grooves in a Y direction provided therein. Generally, light which has passed through the light guide plate 58 or through the light diffuser plate 57 has low directivity, and diffuses in a horizontal direction to make lower brightness of liquid crystal display. Therefore, by laminating the prism sheet 56a for the X direction for converging, in a z direction, illuminating light which diffuses in the X direction from illuminating light that travels in the Z direction from the illuminating device 61 to a display visual recognition side and the prism sheet 56b for the Y direction for converging, in the Z direction, illuminating light which diffuses in the Y direction from the illuminating light that travels in the Z direction from the illuminating device 61 to the display visual recognition side, the directivity of illuminating light to be applied to the liquid crystal panel 51 is made higher.

FIG. 10 is a schematic longitudinal sectional view of the light guide plate 58 (see Japanese Patent Application Laid-open No. Hei 8-29624, for example). A plurality of grooves 62 are formed in an opposing surface of the light guide plate 58. Light emitted from the light source 59 is introduced from the edge portion of the light guide plate 58 into the light guide plate 58. The groove 62 is in a shape of a triangle in section. The light introduced from the edge portion of the light guide plate 58 is reflected in a vertical direction inside inclined surfaces of the triangles of the grooves 62 by inclined surfaces which are nearer to the light source 59. By appropriately setting density of the grooves 62 formed in a lower surface of the light guide plate 58, a depth of the grooves 62, a width of the grooves 62, and a direction of the grooves 62, light having uniform brightness is applied to the liquid crystal panel 51 located thereabove.

In the liquid crystal display device 50 illustrated in FIG. 9, in order to give directivity to illuminating light to be applied to the liquid crystal panel 51, the two prism sheets 56a and 56b are located between the liquid crystal panel 51 and the illuminating device 61. Therefore, the liquid crystal display device 50 becomes thicker correspondingly. Further, the number of parts of the liquid crystal display device 50 is increased and the number of man-hours for assembly is increased to increase the cost.

Further, in the liquid crystal display device 50, by forming the grooves 62 in the light guide plate 58, light from the light source is reflected to give directivity to illuminating light. In order to form the large number of grooves 62 in the light guide plate 58, a material of the light guide plate 58 is made to flow onto an opposing surface of a mold with a large number of prisms formed thereon, and, after the prisms on the mold are transferred to the light guide plate 58, the opposing surface of the mold has to be ground to form the large number of prisms. Therefore, the manufacturing cost of the mold is increased. If a large number of grooves formed in the mold are transferred to manufacture a transfer mold and the material of the light guide plate 58 is made to flow in the transfer mold to form the large number of grooves in the opposing surface of the light guide plate 58, the grinding process may be avoided, but the number of the process steps is increased and the cost is increased.

Further, when grooves each of which is in the shape of a triangle in section are formed in the light guide plate 58 and light is reflected upward by inclined surfaces of the triangles, the directivity of light which passes through the inclined surfaces of the triangles cannot be controlled. Therefore, there arises a problem that the use efficiency of light is decreased.

### SUMMARY OF THE INVENTION

An illuminating device according to the present invention includes a light source and a light guide plate including a light input portion located at a side of the light source, for introducing light from the light source, an exit surface for emitting the light introduced from the light input portion, and an opposing surface which is opposed to the exit surface; and a reflector plate located at the back of the light guide plate. A plurality of light reflecting portions are formed on one of the opposing surface and the exit surface so as to be spaced apart from one another, and a plurality of prisms are formed at each of the plurality of light reflecting portions so as to be adjacent to one another. Each of the plurality of prisms is formed in a shape of a triangle in section with one of the opposing surface and the exit surface being a base of the triangle, so as to protrude therefrom. Therefore, the light introduced into the light guide plate is reflected by inclined surfaces of the plurality of prisms adjacent to one another which are farther from the light input portion to be emitted to outside from the exit surface. Light reflected by inclined surfaces which are nearer to the light input portion of the plurality of prisms adjacent to one another is also reflected again by the inclined surfaces which are farther from the light input portion to be emitted from the exit surface as illuminating light having directivity in a vertical direction.

Further, of base angles formed by one inclined side and the base and another inclined side and the base of each of the triangles in section of the plurality of prisms, the base angle which is farther from the light input portion is substantially the same with regard to all of the plurality of prisms.

Further, the base angle which is farther from the light input portion is in a range of from 35° to 50°. Therefore, illuminating light having the directivity in the vertical direction can be emitted from the exit surface.

Further, of the base angles formed by the one inclined side and the base and the another inclined side and the base of each of the triangles in section of the plurality of prisms, the base angles which are nearer to the light input portion are in a range of from 5° to 45°. This makes it possible to introduce light reflected by the reflector plate again into the light guide plate and confine the light within the light guide plate so that the light is totally reflected by the exit surface and the opposing surface of the light guide plate. Therefore, light which is introduced again is reflected once or twice by the light reflecting portions and can contribute to improvement of the brightness of illuminating light having predetermined directivity.

Further, of the plurality of prisms included in each of the plurality of light reflecting portions, a height of the prism which is nearer to the light input portion is larger than a height of the prism which is farther from the light input portion.

Further, first prisms and second prisms are provided at the light reflecting portions, and the first prisms are located on a side of the light input portion. In the first prisms, of the base angles formed by one inclined side and the base and the another inclined side and the base of each of the triangles in section, the base angle which is nearer to the light input portion is in a range of from 5° to 45°. Further, in the second prisms, of the base angles formed by one inclined side and the base and the another inclined side and the base of each of the triangles in section, the base angle which is nearer to the light input portion is in a range of from 70° to 90°. Therefore, light which has passed through the first prisms is introduced again into the light guide plate and is reflected by the second prism to have predetermined directivity, and thus, can contribute to improvement of the brightness of illuminating light.

Still further, the plurality of light reflecting portions are formed so that a pitch thereamong becomes smaller as a distance from the light input portion increases.

Further, a ratio of an area of each of the light reflecting portions with respect to an area of one of the opposing surface and the exit surface becomes larger as a distance from the light input portion increases. This makes it possible to compensate for softened light which is introduced into the light guide plate as a distance from the light source increases, and thus, uniformity of the brightness of illuminating light emitted from the exit surface can be improved.

Further, a liquid crystal display device includes a liquid crystal panel above the exit surface of the above-mentioned illuminating device.

### BRIEF DESCRIPTION OF THE DRAWINGS

In the accompanying drawings:

FIGS. 1A to 1C are explanatory views for describing basic structures of an illuminating device according to the present invention;

FIG. 2 is a schematic sectional view of an illuminating device in which a single prism is formed at a light reflecting portion;

FIG. 3 is a schematic partial sectional view of an illuminating device according to an embodiment of the present invention;

FIG. 4 is a schematic partial sectional view of an illuminating device according to another embodiment of the present invention;

FIG. 5 is a schematic partial sectional view of an illuminating device according to still another embodiment of the present invention;

FIG. 6 is a schematic plan view of an illuminating device according to yet another embodiment of the present invention;

FIG. 7 is a schematic plan view of an illuminating device according to still another embodiment of the present invention;

FIG. 8 is a schematic sectional view of a liquid crystal display device according to yet another embodiment of the present invention;

FIG. 9 is a schematic sectional view of a conventionally known liquid crystal display device; and

FIG. 10 is a schematic sectional view of a conventionally known light guide plate.

### DETAILED DESCRIPTION OF THE PREFERRED EMBODIMENTS

An illuminating device according to the present invention is capable of applying illuminating light having high directivity to a liquid crystal panel, and hence a prism sheet is not required. Thus, the illuminating device according to the present invention has an advantage that the number of parts can be decreased and a thin liquid crystal display device can be provided at low cost.

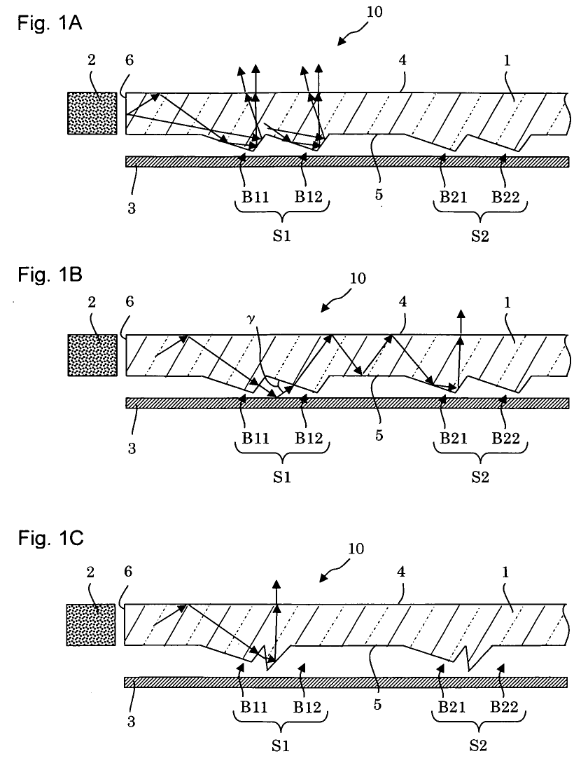

A structure of an illuminating device 10 according to the present invention is described with reference to FIGS. 1A to 1C. FIGS. 1A, 1B, and 1C are schematic partial longitudinal sectional views of the illuminating device 10 according to the present invention, each illustrating a portion around an end portion on a side of a light source 2. The illuminating device 10 according to the present invention includes a transparent light guide plate 1, the light source 2, and a reflector plate 3. The light guide plate 1 is formed of a transparent inorganic material or a transparent resin material. The light source 2 is provided at a side of the light guide plate 1 and light emitted from the light source 2 is introduced into the light guide plate 1 from an end portion thereof. The light guide plate 1 has an exit surface 4 for emitting light and an opposing surface 5 for reflecting and polarizing light. The reflector plate 3 is disposed on a side of the opposing surface 5 of the light guide plate 1. Two light reflecting portions S1 and S2 are formed so as to be spaced apart from each other on the opposing surface 5 of the light guide plate 1. The light reflecting portion S includes a first prism B11 and a second prism B12 which are adjacent to each other. Similarly, the light reflecting portion S2 includes a first prism B21 and a second prism B22. Each of the prisms B11, B12, B21, and B22 is in the shape of a triangle in section with the opposing surface 5 being the base thereof, and is formed so as to protrude from the light guide plate 1. Therefore, two inclined sides of the triangle are each inclined surfaces.

Arrows of FIG. 1A illustrate light emitted from the light source 2, introduced from a light input portion 6 at the side of the light guide plate 1 into the light guide plate 1, reflected by the first prism B11 and the second prism B12, and emitted upward from the exit surface 4. Light introduced into the light guide plate 1 is reflected by inclined surfaces which are farther from the light input portion 6 of the first prism B11 and the second prism B12, and is emitted to the outside from the exit surface 4. Light reflected by inclined surfaces which are nearer to the light input portion 6 of the first prism B11 and the second prism B12 is also reflected by the inclined surfaces which are farther from the light input portion 6, and is emitted from the exit surface 4 as illuminating light having directivity in a vertical direction.

FIG. 1B illustrates light emitted from the light source 2, introduced from the light input portion 6 into the light guide plate 1, and emitted to the outside from the inclined surface which is farther from the light input portion 6 of the first prism B11. When an incident angle of light introduced from the light input portion 6 with respect to a perpendicular line to the exit surface 4 or the opposing surface 5 is relatively small, there may be cases in which the incident angle of light incident on the inclined surface that is farther from the light input portion 6 of the first prism is smaller than a total reflection angle. In such cases, incident light is not totally reflected by and passes through the inclined surface. The transmitted light is reflected by the reflector plate 3 and is introduced again into the light guide plate 1 from the inclined surface which is nearer to the light input portion 6 of the second prism B12. Let an angle between the inclined surface which is nearer to the light input portion 6 of the second prism B12 and light reflected by the reflector plate 3 be γ. The light travels through the light guide plate 1 with total reflection by the exit surface 4 and the opposing surface 5 of the light guide plate 1 being repeated. Further, the light is, for example, totally reflected by the inclined surface which is nearer to the light input portion 6 and by the inclined surface which is farther from the light input portion 6 of the first prism B21 of the light reflecting portion S2, and is emitted from the exit surface 4 of the light guide plate 1.

FIG. 1C illustrates, similarly to FIG. 1B, light emitted from the light source 2, introduced from the light input portion 6 into the light guide plate 1, and emitted to the outside after passing through the inclined surface which is farther from the light input portion 6 of the first prism B11. The transmitted light is introduced again into the light guide plate 1 from the inclined surface which is nearer to the light input portion 6 of the second prism B12, reflected by the inclined surface which is farther from the light input portion 6 of the second prism B12, and is emitted from the exit surface 4 of the light guide plate 1.

As described above, in the illuminating device 10 according to the present invention, by providing the first and second prisms B11 and B12 which are adjacent to each other and the first and second prisms B21 and B22 which are adjacent to each other at the light reflecting portions S1 and S2 formed so as to be spaced apart from each other, respectively, light which has passed through the inclined surface which is farther from the light input portion 6 of the first prism B11 can be again taken in from the inclined surface which is nearer to the light input portion 6 of the second prism B12 to be reused. As a result, the directivity of the illuminating light can be improved to make the brightness higher.

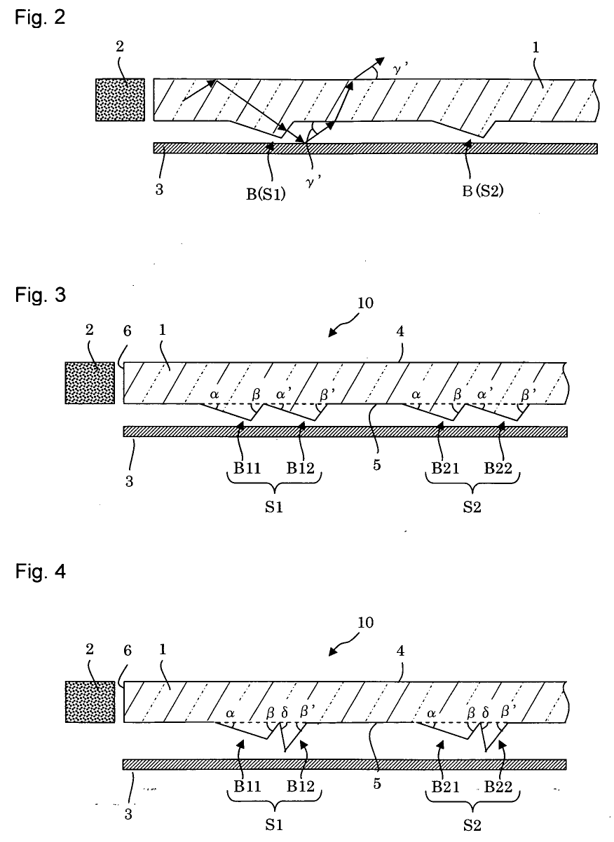

FIG. 2 is a schematic sectional view of an illuminating device for describing an exemplary direction of light when a single prism B is formed at each of the light reflecting portions S1 and S2 formed so as to be spaced apart from each other. A part of light incident on the inclined surface which is farther from the light input portion 6 of the prism B passes through the inclined surface. The transmitted light is reflected by the reflector plate 3 and is introduced again into the light guide plate 1 from the opposing surface 5 of the light guide plate 1 so as to form an angle γ′ with the opposing surface 5. However, the opposing surface and the opposite exit surface are in parallel with each other, and hence the light which is introduced again is not totally reflected by the exit surface 4 of the light guide plate 1 and is emitted from the exit surface 4 at the angle γ′. The angle γ′ of the emitted light is small, whereby the light cannot contribute to image display of a liquid crystal display device or the like. In other words, when the first and second prisms B11 and B12 of the light reflecting portion S1 are formed so as to be adjacent to each other as illustrated in FIG. 1B, compared with the case in which the single prism B is formed at the light reflecting portion S1 as illustrated in FIG. 2, the directivity of light can be improved to make higher the brightness of the illuminating device.

It is to be noted that, the illuminating devices 10 according to the present invention illustrated in FIGS. 1A, 1B, and 1C have a large number of the light reflecting portions S1 and S2 formed therein. Further, the number of the prisms formed so as to be adjacent to each other at each of the light reflecting portions S1 and S2 is not limited to two, and three such prisms may be formed so as to be adjacent to one another or still more prisms may be formed so as to be adjacent to one another. Further, the light reflecting portions S1 and S2 may be formed on the exit surface 4. In this case, by introducing light which changes its direction by being reflected by the prisms of the light reflecting portions S1 and S2 to the side of the reflector plate 3 and reflecting the light by the reflector plate 3, illuminating light can be applied from above the exit surface 4.

With reference to the drawings, specific embodiments of the present invention are now described in the following.

### Embodiment 1

FIG. 3 is a schematic partial longitudinal sectional view of an illuminating device 10 according to Embodiment 1 of the present invention. Like numerals denote like or identical parts.

As illustrated in FIG. 3, the illuminating device 10 includes the light guide plate 1, the light source 2, and the reflector plate 3. The light guide plate 1 has the exit surface 4 for emitting illuminating light and the opposing surface 5 for reflecting light to change the direction of the light. The opposing surface 5 of the light guide plate 1 includes the plurality of light reflecting portions S1 and S2 which are formed so as to be spaced apart from each other. The light reflecting portions S1 and S2 have the first and second prisms B11 and B12 and the first and second prisms B21 and B22 formed therein, respectively. Each of the prisms B11, B12, B21, and B22 is in the shape of a triangle in section with the opposing surface 5 being the base thereof, and is formed so as to protrude from the light guide plate 1. The light source 2 is located in proximity to the end portion of the light guide plate 1, and light from the light source 2 is introduced from the light input portion 6.

In the light reflecting portion S1, the inclined surface which is nearer to the light input portion 6 of the first prism B11 (that is, the inclined side which is nearer to the light input portion 6 of the triangle) forms an angle α with the opposing surface 5 while the inclined surface which is farther from the light input portion 6 of the first prism B11 (that is, the inclined side which is farther from the light input portion 6 of the triangle) forms an angle β with the opposing surface 5. The second prism B12 is substantially similar in shape to the first prism B11. More specifically, the inclined surface which is nearer to the light input portion 6 of the second prism B12 (that is, the inclined side which is nearer to the light input portion 6 of the triangle) forms an angle α′ with the opposing surface 5, and the angle α′ is substantially equal to the angle α of the first prism B11. The inclined surface which is farther from the light input portion 6 of the second prism B12 (that is, the inclined side which is farther from the light input portion 6 of the triangle) forms an angle β′ with the opposing surface 5, and the angle β′ is substantially equal to the angle β of the first prism B11. The first and second prisms B21 and B22 of the light reflecting portion S2 are formed similarly to the case of the first and second prisms B11 and B12 of the above-mentioned light reflecting portion S1.

Here, the angles β and β′ between the inclined surfaces which are farther from the light input portion 6 of the prisms B11, B12, B21, and B22 and the opposing surface 5 are set to be from 35° to 50°. This makes it possible to emit from the exit surface 4 illuminating light having directivity in the vertical direction. More preferably, the angles β and β′ are set to be from 40° to 45°. This can make still higher the brightness of the reflected light having directivity in the vertical direction.

Meanwhile, the angles α and α′ between the inclined surfaces which are nearer to the light input portion 6 of the prisms B11, B12, B21, and B22 and the opposing surface 5 are set to be from 5° to 45°. This makes it possible to introduce light reflected by the reflector plate 3 again into the light guide plate 1 and confine the light within the light guide plate 1 so that the light is totally reflected by the exit surface 4 and the opposing surface 5 of the light guide plate 1. Light which is introduced again is reflected once or twice by the light reflecting portions S1 and S2 and contributes to improvement of the brightness of illuminating light having predetermined directivity.

Preferably, a thickness of the light guide plate 1 is in the range of from 0.4 mm to 1 mm, each length of the bases of the prisms B11, B12, B21, and B22 is in the range of from 10 μm to 50 μm, and each height from the bases to vertices of the triangles is in the range of from 1 μm to 20 μm. Further, a distance between the opposing surface 5 of the light guide plate 1 and a reflecting surface of the reflector plate 3 is preferably in the range of from 10 μm to 100 μm.

It is to be noted that the number of the formed light reflecting portions S1 and S2 may be large according to a size of the illuminating device 10. Further, the number of the prisms forming each of the light reflecting portions S1 and S2 is not limited to two, and three or still more prisms may be formed so as to be adjacent to one another. Further, the light source 2 may be an LED. An LED can be formed so as to be thinner than a cold-cathode tube, and hence the illuminating device 10 can be formed so as to be still thinner.

### Embodiment 2

FIG. 4 is a schematic partial longitudinal sectional view of an illuminating device 10 according to Embodiment 2 of the present invention. Like numerals denote like or identical parts.

As illustrated in FIG. 4, the illuminating device 10 includes the light guide plate 1, the light source 2, and the reflector plate 3. The light guide plate 1 has the exit surface 4 for emitting illuminating light and the opposing surface 5 for reflecting light to change the direction of the light. The opposing surface 5 of the light guide plate 1 includes the plurality of light reflecting portions S1 and S2 which are formed so as to be spaced apart from each other. The light reflecting portions S1 and S2 have the first and second prisms B11 and B12 and the first and second prisms B21 and B22 formed therein, respectively. Each of the prisms B11, B12, B21, and B22 is in the shape of a triangle in section with the opposing surface 5 being the base thereof, and is formed so as to protrude from the light guide plate 1. The light source 2 is located in proximity to the end portion of the light guide plate 1, and light from the light source 2 is introduced from the light input portion 6.

In the light reflecting portion S1, the inclined surface which is nearer to the light input portion 6 of the first prism B11 (that is, the inclined side which is nearer to the light input portion 6 of the triangle) forms the angle α with the opposing surface 5 while the inclined surface which is farther from the light input portion 6 of the first prism B11 (that is, the inclined side which is farther from the light input portion 6 of the triangle) forms the angle β with the opposing surface 5. The inclined surface which is nearer to the light input portion 6 of the second prism B12 (that is, the inclined side which is nearer to the light input portion 6 of the triangle). forms an angle δ with the opposing surface 5, and the inclined surface which is farther from the light input portion 6 of the second prism B12 (that is, the inclined side which is farther from the light input portion 6 of the triangle) forms the angle β′ with the opposing surface 5. The angle β′ is substantially equal to the angle β of the first prism B11. The first and second prisms B21 and B22 of the light reflecting portion S2 are formed similarly to the case of the first and second prisms B11 and B12 of the above-mentioned light reflecting portion S1.

Here, the angles β and β′ between the inclined surfaces which are farther from the light input portion 6 of the prisms B11, B12, B21, and B22 and the opposing surface 5 are set to be from 35° to 50°. This makes it possible to emit from the exit surface 4 illuminating light having directivity in the vertical direction. More preferably, the angles β and β′ are set to be from 40° to 45°. This can make still higher the brightness of the reflected light having directivity in the vertical direction.

Meanwhile, the angle δ between the inclined surfaces which are nearer to the light input portion 6 of the prisms B12 and B22 and the opposing surface 5 is set to be from 70° to 90°. This makes it possible to introduce light which has passed through the prisms B11 and B21 again into the light guide plate 1 to be reflected by the prisms B12 and B22, and the light contributes to improvement of the brightness of illuminating light having predetermined directivity.

In the illuminating device 10 according to Embodiment 2 described above, for example, preferably, a thickness of the light guide plate 1 is in the range of from 0.4 mm to 1 mm, lengths of the bases of the prisms B11, B12, B21, and B22 are in the range of from 10 μm to 50 μm, and heights from the bases to vertices of the triangles are in the range of from 1 μm to 20 μm. Further, a distance between the opposing surface 5 of the light guide plate 1 and the reflector plate 3 is preferably in the range of from 10 μm to 100 μm.

It is to be noted that the number of the formed light reflecting portions S1 and S2 may be large according to a size of the illuminating device 10. Further, the number of the prisms forming each of the light reflecting portions S1 and S2 is not limited to two, and three or still more prisms may be formed so as to be adjacent to one another. In Embodiment 2, one first prism and a plurality of second prisms may be formed at one light reflecting portion.

Further, the light source 2 maybe an LED. An LED can be formed so as to be thinner than a cold-cathode tube, and hence the illuminating device 10 can be formed so as to be still thinner.

### Embodiment 3

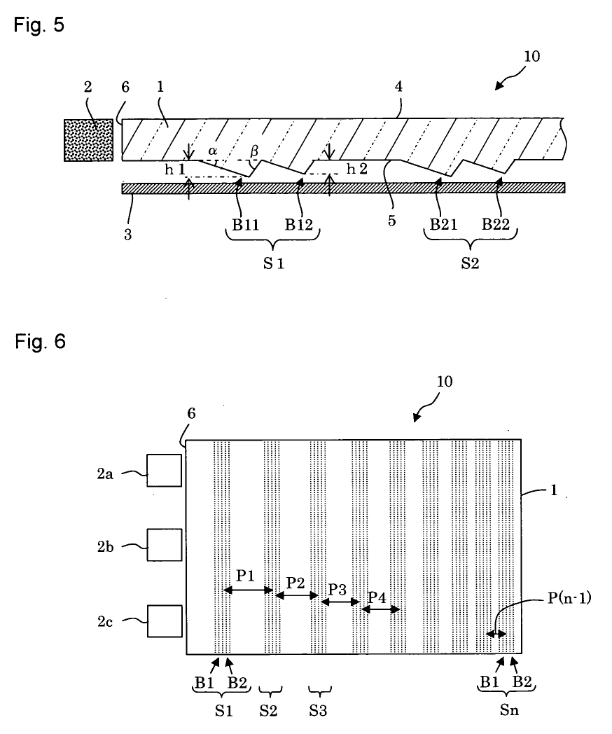

FIG. 5 is a schematic partial longitudinal sectional view of an illuminating device 10 according to Embodiment 3 of the present invention. In Embodiment 3, of the first and second prisms B11 and B12 adjacent to each other or of the first and second prisms B21 and B22 adjacent to each other which are included in the light reflecting portion S1 or S2, each height of the prisms B11 and B21 which are nearer to the light input portion 6 is larger than each height of the prisms B12 and B22 which are farther from the light input portion 6. Like numerals denote like or identical parts.

The illuminating device 10 illustrated in FIG. 5 includes the light guide plate 1, the light source 2, and the reflector plate 3. The light guide plate 1 introduces light from the light input portion 6 thereof and emits illuminating light from the exit surface 4. The opposing surface 5 includes the light reflecting portions S1 and S2 which are formed so as to be spaced apart from each other. The light reflecting portion S1 has the first prism B11 and the second prism B12 adjacent to the first prism B11 formed therein. The light reflecting portion S2 has the first prism B21 and the second prism B22 adjacent to the first prism B21 formed therein. Each of the prisms B11, B12, B21, and B22 is in the shape of a triangle in section with the opposing surface 5 being the base thereof, and is formed so as to protrude from the light guide plate 1.

The prism B11 which is nearer to the light input portion 6 and the prism B12 which is farther from the light input portion 6 of the light reflecting portion S1 are substantially similar in shape to each other. The inclined surface which is nearer to the light input portion 6 of the prism B11 forms the angle α with the opposing surface 5, and the inclined surface which is farther from the light input portion 6 of the prism B11 forms the angle β with the opposing surface 5. A height h1 of the prism B11 from the opposing surface 5, which is nearer to the light input portion 6, is larger than a height h2 of the prism B12 from the opposing surface 5, which is farther from the light input portion 6. With regard to the light reflecting portion S2, similarly to the case of the light reflecting portion S1, the first prism B21 and the second prism B22 are formed.

This decreases an area of the inclined surface which is farther from the light input portion 6 of the second prism B12 which is at a stage subsequent to the first prism B11 with respect to the light input portion 6. Therefore, an amount of light which passes through the inclined surface and can not be used as illuminating light having directivity can be decreased. Further, light which has passed through the inclined surface which is farther from the light input portion 6 of the first prism B11 which is at a stage previous to the second prism B12 with respect to the light input portion 6 is reflected by the reflector plate 3. The reflected light is introduced again into the light guide plate 1 from the inclined surface which is nearer to the light input portion 6 of the second prism B12, confined within the light guide plate 1, and emitted upward as light having directivity from another light reflecting portion. As a result, intensity of light having predetermined directivity can be made higher.

Further, even when three or more prisms are formed so as to be adjacent to one another at each of the light reflecting portions S1 and S2, the prisms are formed so that the heights thereof gradually become lower as the distance from the light input portion 6 increases. As a result, the area of the inclined surface which is farther from the light input portion 6 of the prism which is the farthest from the light input portion 6 is decreased, and the amount of light which passes through the inclined surface is decreased, with the result that the amount of light which can not be used as illuminating light having predetermined directivity is decreased. In other words, the brightness of illuminating light can be made higher.

### Embodiment 4

FIG. 6 is a schematic plan view of an illuminating device 10 according to Embodiment 4 of the present invention. Like numerals denote like or identical parts.

The illuminating device 10 illustrated in FIG. 6 includes the light guide plate 1, a plurality of light sources 2a, 2b, and 2c, and the reflector plate 3 (not shown). Light reflecting portions S1, S2, . . . , and Sn are formed on the opposing surface 5 of the light guide plate 1. A first prism B1 and a second prism B2 are formed at each of the light reflecting portions S1, S2, . . . , and Sn. Each of the prisms B1 and B2 is in the shape of a triangle in section with the opposing surface 5 of the light guide plate 1 being the base thereof. The shapes of the prisms are similar to those in Embodiments 1 to 3 described above and thus, description thereof is omitted.

Distances P1, P2, . . . , and P(n−1) between the light reflecting portions S1 and S2, S2 and S3, . . . , and S(n−1) and Sn are adapted to become smaller as the distance from the light input portion 6 of the light guide plate 1 increases. This makes it possible to compensate for softened light which is introduced into the light guide plate 1 as the distance from the light source 2 increases, and thus, uniformity of the brightness of illuminating light emitted from the exit surface 4 of the light guide plate 1 can be improved.

### Embodiment 5

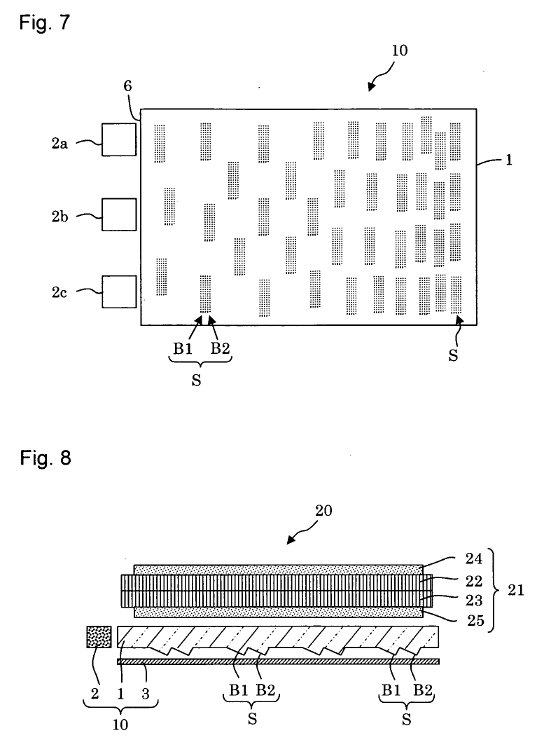

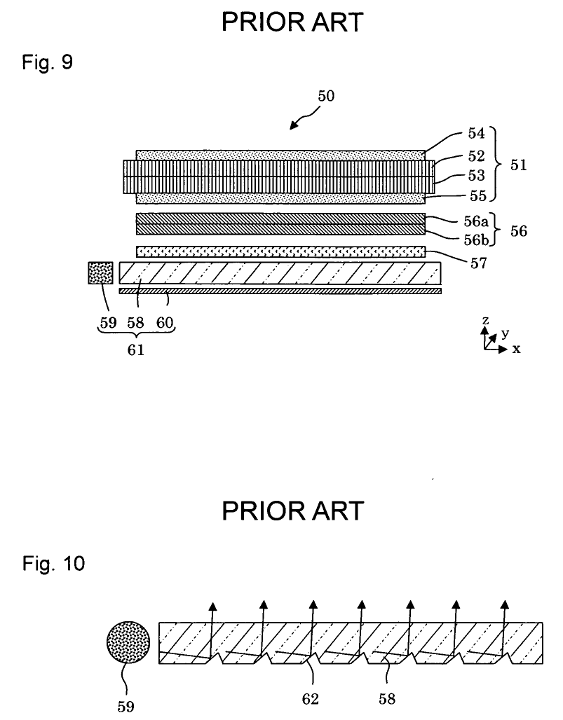

FIG. 7 is a schematic plan view of an illuminating device 10 according to Embodiment 5 of the present invention. Like numerals denote like or identical parts.

The illuminating device 10 illustrated in FIG. 7 includes the light guide plate 1, the plurality of light sources 2a, 2b, and 2c, and the reflector plate 3 (not shown). A large number of light reflecting portions S each having a predetermined width and length are formed on the opposing surface 5 of the light guide plate 1. The first prism B1 and the second prism B2 adjacent to the first prism B1 are formed at each of the light reflecting portions S. Each of the prisms B1 and B2 is in the shape of a triangle in section with the opposing surface 5 of the light guide plate 1 being the base thereof. The shapes of the prisms are similar to those in Embodiment 1 or 2 described above and thus, description thereof is omitted.

The light reflecting portions S in a predetermined shape are disposed so as to be denser as the distance from the light input portion 6 of the light guide plate 1 increases. More specifically, the ratio of the area of the light reflecting portions S with respect to the area of the opposing surface 5 of the light guide plate 1 becomes larger as the distance from the light input portion 6 of the light guide plate 1 increases. This makes it possible to compensate for softened light which is introduced into the light guide plate 1 as the distance from the light source 2 increases, and thus, uniformity of the brightness of illuminating light emitted from the exit surface 4 of the light guide plate 1 can be improved.

### Embodiment 6

FIG. 8 is a schematic longitudinal sectional view of a liquid crystal display device 20 according to Embodiment 6 of the present invention. Like numerals denote like or identical parts.

The liquid crystal display device 20 illustrated in FIG. 8 includes a liquid crystal panel 21 and the illuminating device 10 provided therebelow. The liquid crystal panel 21 includes upper and lower transparent substrates 22 and 23, a liquid crystal layer (not shown) sandwiched between the two transparent substrates 22 and 23, and upper and lower polarizing plates 24 and 25 attached to outer surfaces of the upper and lower transparent substrates 22 and 23, respectively. The illuminating device 10 includes the light guide plate 1, the light source 2 for applying light to the light guide plate 1, and the reflector plate 3. The plurality of light reflecting portions S are formed so as to be spaced apart from one another on the opposing surface 5. of the light guide plate 1. The two prisms B1 and B2 which are adjacent to each other are formed at each of the light reflecting portions S. Each of the prisms B1 and B2 is in the shape of a triangle in section with the opposing surface of the light guide plate 1 being the base thereof. Angles between the inclined surfaces which are farther from the light input portion 6 of the prisms B1 and B2 and the opposing surface are in the range of from 35° to 50°, and preferably in the range of from 40° to 45°. Angles between the inclined surfaces which are nearer to the light input portion 6 of the prisms B1 and B2 and the opposing surface are in the range of from 5° to 45°.

Illuminating light emitted from the illuminating device 10 has directivity in which the light converges in a specific range in a direction perpendicular to the exit surface 4, and hence it is not necessary to insert a prism sheet between the liquid crystal panel 21 and the illuminating device 10. Therefore, the liquid crystal display device 20 can be formed so as to be thinner, and, because the number of parts can be decreased and the number of man-hours for assembly can be decreased, the cost can be decreased.

It is to be noted that, the embodiment in which the light reflecting portions S are formed on the opposing surface of the light guide plate 1 has been described, but the present invention is not limited thereto.

Even when the light reflecting portions S are formed on the exit surface 4 of the light guide plate 1, effects similar to those when the light reflecting portions S are formed on the opposing surface can be obtained. When the light reflecting portions S are formed on the side of the exit surface 4, light introduced from the light source 2 is reflected by the light reflecting portions S to be emitted from the opposing surface 5, and reflected by the reflector plate 3 disposed on the side of the opposing surface 5. Then, the light is introduced again into the light guide plate, and emitted as illuminating light from the side of the exit surface 4.

What is claimed is:

1. An illuminating device, comprising:
a light source;
a light guide plate including:
a light input portion located at a side of the light source, for introducing light from the light source;
an exit surface for emitting the light introduced from the light input portion; and
an opposing surface which is opposed to the exit surface;
a reflector plate located on a back of the light guide plate;
a plurality of light reflecting portions formed on one of the opposing surface and the exit surface so as to be spaced apart from one another; and
a plurality of prisms formed at each of the plurality of light reflecting portions so as to be adjacent to one another,
wherein each of the plurality of prisms is formed in a shape of a triangle in section with one of the opposing surface and the exit surface being a base of the triangle, so as to protrude therefrom.

2. An illuminating device according to claim 1, wherein, of base angles formed by one inclined side and the base and another inclined side and the base of the triangle, the base angle which is farther from the light input portion is substantially the same with regard to all of the plurality of prisms.

3. An illuminating device according to claim 2, wherein, of the base angles formed by the one inclined side and the base and the another inclined side and the base of the triangle, the base angle which is farther from the light input portion is in a range of from 35° to 50°.

4. An illuminating device according to claim 3, wherein, of the base angles formed by the one inclined side and the base and the another inclined side and the base of the triangle, the base angle which is nearer to the light input portion is in a range of from 5° to 45°.

5. An illuminating device according to of claim 1, wherein, of the plurality of prisms included in each of the plurality of light reflecting portions, a height of the prism which is nearer to the light input portion is larger than a height of the prism which is farther from the light input portion.

6. An illuminating device according to claim 1, wherein:
each of the plurality of light reflecting portions includes a first prism and a second prism;
the first prism is located on a side of the light input portion, and, of base angles formed by one inclined side and the base and the another inclined side and the base of the triangle of the first prism, the base angle which is nearer to the light input portion is in a range of from 5° to 45°; and
of base angles formed by one inclined side and the base and the another inclined side and the base of the triangle of the second prism, the base angle which is nearer to the light input portion is in a range of from 70° to 90°.

7. An illuminating device according to claim 1, wherein the plurality of light reflecting portions are formed so that a pitch thereamong becomes smaller as a distance from the light input portion increases.

8. An illuminating device according to claim 1, wherein a ratio of an area of each of the plurality of light reflecting portions with respect to an area of one of the opposing surface and the exit surface becomes larger as a distance from the light input portion increases.

9. A liquid crystal display device, comprising:
an illuminating device; and
a liquid crystal panel located above the illuminating device,
the illuminating device including:
a light source;
a light guide plate including:
a light input portion located at a side of the light source, for introducing light from the light source;
an exit surface for emitting the light introduced from the light input portion; and
an opposing surface which is opposed to the exit surface;
a reflector plate located on a back of the light guide plate;
a plurality of light reflecting portions formed on one of the opposing surface and the exit surface so as to be spaced apart from one another; and
a plurality of prisms formed at each of the plurality of light reflecting portions so as to be adjacent to one another,
wherein each of the plurality of prisms is formed in a shape of a triangle in section with one of the opposing surface and the exit surface being a base of the triangle, so as to protrude therefrom.
